(19) United States
(12) Patent Application Publication
(10) Pub. No.: US 2006/0001631 A1
(43) Pub. Date: Jan. 5, 2006

(54) Display control device of liquid crystal display apparatus, and liquid crystal display apparatus having same

(75) Inventor: Hiroshi Yamazaki, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 11/084,340

(22) Filed: Mar. 18, 2005

(30) Foreign Application Priority Data
Jun. 30, 2004 (JP) 2004-192910

(51) Int. Cl. G09G 3/36

(52) U.S. Cl. 345/98

(57) ABSTRACT

A display control device to which an external clock as well as image data are supplied, and which supplies timing control signals to control the driving timing of the data driver and gate driver of the liquid crystal display panel, comprising an internal clock generation unit which generates an internal clock without depending on the external clock; buffer memory to which the supplied image data is written in synchronization with the external clock; and a timing control unit which supplies the image data written to the buffer memory to the data driver in synchronization with the internal clock, and generates, in synchronization with the internal clock, a timing control signal including, at least, a voltage application signal to control the timing of application to data lines of data voltages and a gate clock signal to control a driving timing of the gate line.

### CROSS-REFERENCE TO RELATED APPLICATIONS

This application is based upon and claims the benefit of priority from the prior Japanese Patent Application No. 2004-192910, filed on Jun. 30, 2004, the entire contents of which are incorporated herein by reference.

### BACKGROUND OF THE INVENTION

1. Field of the Invention

This invention relates to a display control device of a liquid crystal display apparatus and a liquid crystal display apparatus having such a device, and in particular relates to a display control device capable of securing the timing margin of a liquid crystal panel without depending on an external clock signal, and to a liquid crystal display apparatus having such a device.

2. Description of the Related Art

A liquid crystal display apparatus has a display panel having a liquid crystal layer, gate drivers which drive the display panel, data drivers, and a display control device which controls the gate drivers and data drivers; the apparatus is supplied with image data and a clock signal from a personal computer or other display signal supply apparatus, and displays an image corresponding to the image data.

The liquid crystal display apparatus latches the supplied image data supplied in synchronization with an externally supplied input clock, generates a timing control signal for internal panel driving in synchronization with the input clock, and through this timing control signal controls the operation to drive data lines and gate lines by the data drivers and gate drivers. Thus the input image data is input in synchronization with the input clock input from the display signal supply apparatus, to generate display panel control signals.

For example, a display control device for a liquid crystal display apparatus is proposed in Japanese Patent Laid-open No. 2003-66911. This patent describes a method in which image data is written to one pair of a left line memory unit and right line memory unit in synchronization with the input clock, and data is read in parallel from the pair of left and right line memory units and supplied to the data driver. According to this patent, image data is read in parallel from a plurality of line memory units in synchronization with an internally generated clock and is supplied to the data driver, so that the supply of image data to the data driver can be performed reliably. However, there is no description of a timing control signal to control the timing of the data drivers and gate drivers.

As described above, excluding some exceptions, the display control device of conventional liquid crystal display apparatuses controls the driving timing of the display panel in synchronization with an input clock. However, the larger sizes of liquid crystal display panels and increases in the number of pixels in recent years have been accompanied by stricter margins for the driving timing of gate lines and for the driving timing of data lines. Further, more complicated driving control than in the past has become necessary for this driving, so that there is a trend for various timing margins to become more strict, that is, to become smaller.

On the other hand, there is increased scattering in the clock speeds on the side of the personal computer or other display signal supply apparatus, and often display signals are supplied at clock speeds exceeding the prescribed stipulated range, so that together with the above-described reductions in timing margins, there is the problem that stable display control is no longer possible merely through control of the driving timing of the display panel in synchronization with an external clock signal.

### SUMMARY OF THE INVENTION

Hence an object of the invention is to provide a display control device for a liquid crystal display apparatus enabling stable display control without depending on the frequency of an external clock signal, as well as a liquid crystal display apparatus using such a display control device.

In order to attain the above object, a first perspective of this invention is a display control device to which an external clock as well as image data are supplied, and which supplies timing control signals to control the driving timing of the data driver and gate driver of the liquid crystal display panel, comprising an internal clock generation unit which generates an internal clock without depending on the external clock; buffer memory to which the supplied image data is written in synchronization with the external clock; and a timing control unit which supplies the image data written to the buffer memory to the data driver in synchronization with the internal clock, and generates, in synchronization with the internal clock, a timing control signal including, at least, a voltage application signal to control the timing of application to data lines of data voltages corresponding to the image data by the data driver, and a gate clock signal to control a driving timing of the gate line by the above gate drivers.

In a preferred embodiment of the above first perspective, the timing control unit is characterized in that the data hold time over which application of data voltage to the data line is continued after the end of driving of the gate lines, and the charge share time over which adjacent data lines are short-circuited prior to data voltage application to the data line, are controlled so as to be in synchronization with the internal clock.

In order to attain the above object, a second perspective of the invention is a liquid crystal display apparatus comprising the display control device of the first perspective, a liquid crystal display panel, data driver, and gate driver.

By means of the above first perspective of the invention, the timing control signal for the driving circuits of a liquid crystal display panel is generated in synchronization with an internal clock not dependent on the input clock, rather than with the input clock supplied externally, so that stable display control is possible through the timing control signal which satisfies the various driving margins of the driver circuit.

### BRIEF DESCRIPTION OF THE DRAWINGS

FIG. 1 shows the configuration of a liquid crystal display apparatus of one aspect;

FIG. 2 shows the configuration of a gate driver and data driver;

FIG. 3 shows the operating waveforms in the display control device when synchronized with an external clock;

FIG. 4 shows the operating waveforms in the display control device when synchronized with an external clock;

FIG. 5 shows the configuration of the timing control unit in the display control device in the aspect;

FIG. 6 shows the operating waveforms of the display control device in an aspect;

FIG. 7 shows the operating waveforms of the display control device in the aspect;

FIG. 8 shows the configuration of a liquid crystal display apparatus in a modified example of an aspect; and,

FIG. 9 shows the operating waveforms in the display control device of FIG. 8.

### DESCRIPTION OF THE PREFERRED EMBODIMENTS

Below, aspects of the invention are explained using the drawings. However, the technical scope of this invention is not limited to these aspects, but extend to the inventions described in the scope of claims, and to inventions equivalent thereto.

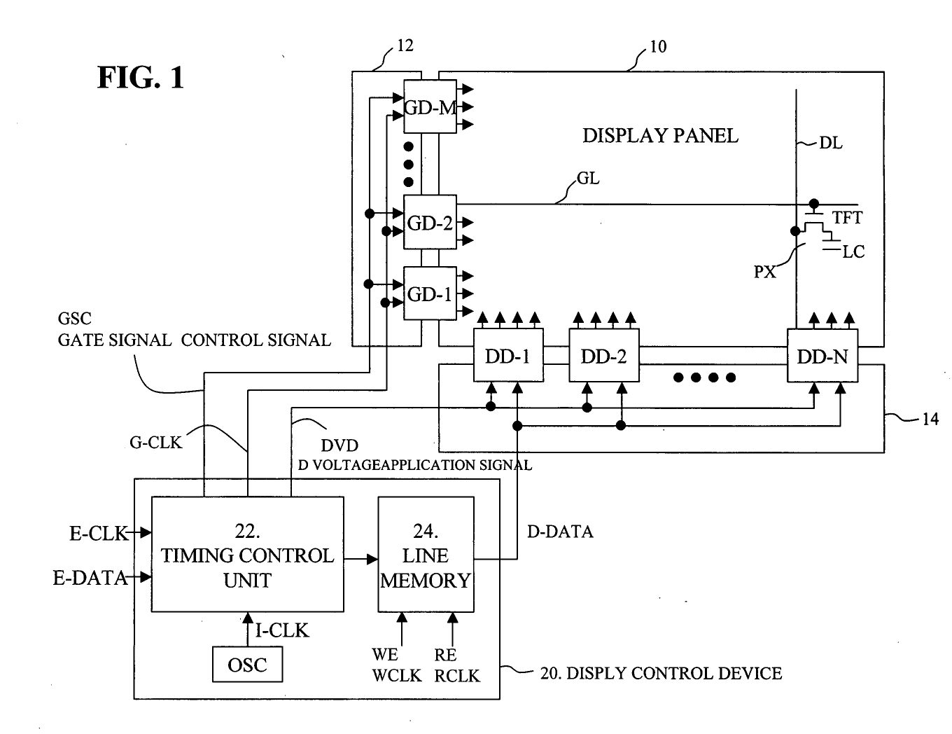

FIG. 1 shows the configuration of a liquid crystal display apparatus of one aspect. The liquid crystal display apparatus has a liquid crystal display panel 10; a plurality of gate drivers GD-1 to GD-M which drive gate lines GL arranged in the horizontal direction of the display panel in synchronization with a horizontal sync signal, and a plurality of data drivers DD-1 to DD-N which apply a data voltage corresponding to image data to data lines DL arranged in the vertical direction of the display panel in synchronization with a horizontal sync signal; and a display control device 20 which controls the operation timing of these drivers. A plurality of gate lines GL are arranged in the horizontal direction, and a plurality of data lines DL are arranged in the vertical direction, on the display panel 10; at the positions of intersections of these lines are positioned pixels PX, each having a cell transistor TFT and liquid crystal pixel LC. The plurality of gate drivers GD are provided on a gate driver substrate 12, and drive the respective plurality of gate lines. The plurality of data drivers DD are provided on the data driver substrate 14, and apply data voltages to the respective plurality of data lines.

Further, image data E-DATA is supplied to the display control device 20 in synchronization with an input clock E-CLK from a personal computer or other display signal supply apparatus, and the display control device 20 generates the above-described timing control signals for drivers, which are the gate signal control signal GSG, gate clock G-CLK, and data line voltage application signal DVD, as well as the internal image data D-DATA, and supplies these to the drivers GD and DD. The display control device 20 has an internal clock generation oscillator circuit OSC, which generates an internal clock I-CLK having a constant frequency without depending on the input clock; a timing control unit 22, which generates timing control signals; and line memory 24, as buffer memory for temporarily storage of input image data E-DATA.

The timing control unit 22 writes the supplied image data E-DATA to line memory 24 in synchronization with the input clock E-CLK, and generates the above timing control signals in synchronization with the internal clock I-CLK, while also reading data written to line memory 24 in synchronization with the internal clock I-CLK and supplying the data to the data drivers DD. Details of this operation are described below.

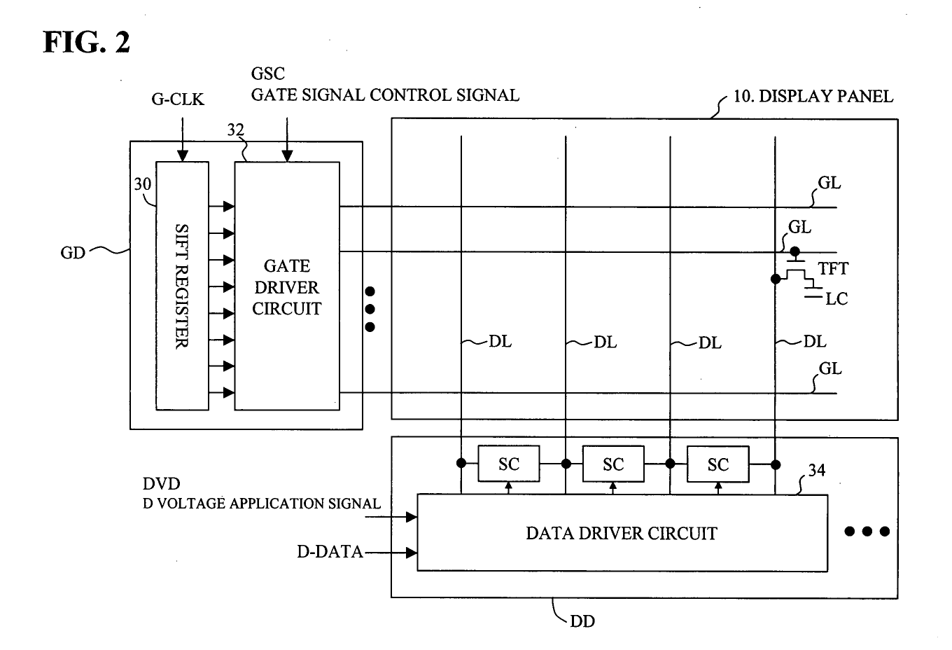

FIG. 2 shows the configuration of a gate driver and data driver. The gate driver GD has a shift register 30 which shifts data in synchronization with the gate clock G-CLK, and a gate driver circuit 32 which applies a prescribed gate voltage waveform to corresponding gate lines GL in response to output from the shift register 30. This gate driver circuit 32 forms the gate voltage waveform into a prescribed shape, described below, in response to the timing of the gate signal control signal GSC. The data driver DD has a data driver circuit 34 which generates a data voltage for data lines corresponding to the internal data D-DATA and applies this data voltage to the data lines, and a data line shorting circuit SC which short-circuits adjacent data lines prior to the application of data voltages to data lines.

With the goal of lengthening the lifetime of the liquid crystals, a liquid crystal display panel is generally driven using an inverted driving method, in which the polarities of the voltages applied to adjacent data lines are inverted at each horizontal sync interval. In this case, in neighboring horizontal sync intervals, data voltages for application are generated in the current horizontal sync interval with polarities opposite those of the applied voltage polarities in the previous horizontal sync interval. In order not to waste the power applied in the previous horizontal sync interval, the adjacent data lines are short-circuited, the charge on the two data lines is shared, and thereafter data voltages of opposite polarities are applied. By optimizing the short-circuited time, power consumption can be reduced without wasting the charge in the data lines. Hence the timing of control to short-circuit adjacent data lines is controlled through the data line voltage application signal DVD. Hence the timing of this data line voltage application signal DVD affects power consumption.

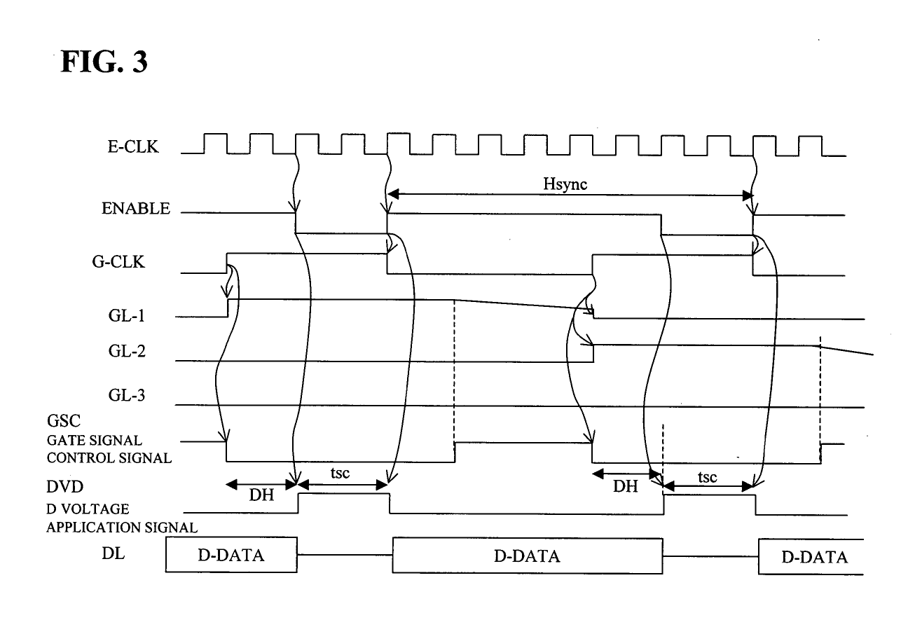

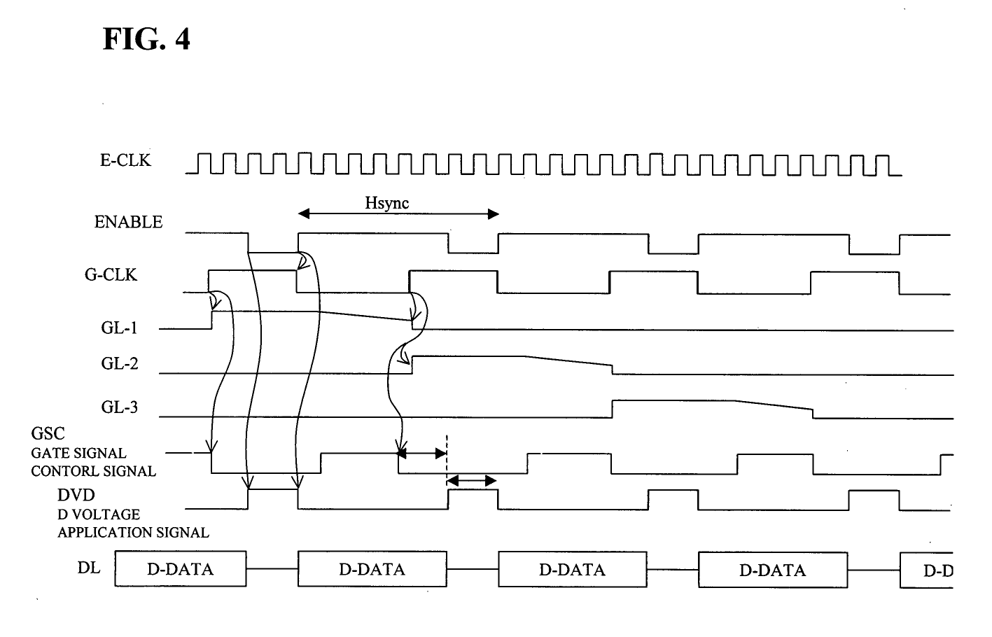

FIG. 3 and FIG. 4 show the operating waveforms in the display control device when synchronized with an external clock. In the prior art, timing control signals for the display panel are generated in synchronization with the external clock E-CLK. The personal computer or other display signal supply apparatus supplies the clock for synchronization E-CLK and image data E-DATA, in which is embedded display sync signal information, to the display control device 20 of the liquid crystal display apparatus. Based on the display sync signal information embedded in the image data, the display control device 20 generates an enable signal ENABLE in synchronization with the input clock E-CLK. This enable signal is a display sync signal to control the horizontal sync interval and vertical sync interval. In other cases, the personal computer or other display signal supply apparatus may supply a clock for synchronization E-CLK and enable signal ENABLE, as well as the image data E-DATA. In such cases, the enable signal and the image data E-DATA are both synchronized with the input clock E-CLK.

The gate clock G-CLK rises earlier, by a prescribed time, than the rising edge of the enable signal ENABLE, and falls in response to the rising edge of the enable signal ENABLE, to control the scan timing of gate lines. That is, the gate lines GL-1, GL-2, GL-3 are scanned and driven in sequence, in synchronization with the rising edges of the gate clock G-CLK. The gate signal control signal GSC is a timing control signal which falls in response to the rising edge of the gate clock G-CLK and rises after a prescribed time, and is controlled such that the driving waveforms of the gate lines GL-1, GL-2 fall gradually from H level in response to the rising edge of the gate signal control signal GSC. The gate line driving waveform is made to decline in order that the voltage waveform applied to gate lines extending in the horizontal direction of the display panel is not blunted on the opposite side of the gate driver.

The data voltage application signal DVD, which rises at the falling edge and falls at the rising edge of the enable signal ENABLE, is a timing control signal for the short-circuit circuit which causes adjacent data lines to be short-circuited; during the time tSC when the data voltage application signal DVD is at H level, adjacent data lines are short-circuited. Hence during the time tSC of short-circuiting (or the charge-sharing time) from the start of the horizontal sync interval Hsync, the adjacent data lines are short-circuited, and thereafter, while the data voltage application signal DVD is at L level, the data lines DL are driven by data voltage corresponding to the image data D-DATA. That is, the data voltage application signal DVD controls the timing of voltage application to the data lines DL. Even after the gate voltage has been applied to the gate lines GL-1, GL-2, the data voltage continues to be applied to the data lines DL for a prescribed data hold time DH.

The above data hold time DH affects the driving characteristics of the liquid crystal display panel, and so must be confined to within a predetermined time. Similarly, in order that the charge accumulated during the previous horizontal sync interval is utilized effectively so as not to waste driving power, a predetermined time must be secured for the short-circuit time (charge-sharing time) tGS, and by this means, power conservation can be optimized.

FIG. 4 shows the operating waveforms in the display control device when the input clock is a fast clock signal. In these operating waveforms also, timing control signals G-CLK, GSC, and DVD to drive the display panel are generated in synchronization with the input clock E-CLK. However, because the input clock E-CLK is faster, the different timing control signals synchronized with this clock are also faster, so that the short-circuit interval (charge-sharing time) tSC and data hold interval DH generated by these timing control signals are shortened, the timing margins assumed in the design of the display cannot can no longer be secured, and stable display panel operation is no longer possible. This problem of timing margins has grown more serious in recent years due to larger display panel sizes and increases in the number of pixels. Hence there is a tendency for methods in which an input clock is used to synchronize timing control for a liquid crystal display panel with more strict timing margins are tending to become inappropriate for display panels which are larger in size or have greater numbers of pixels.

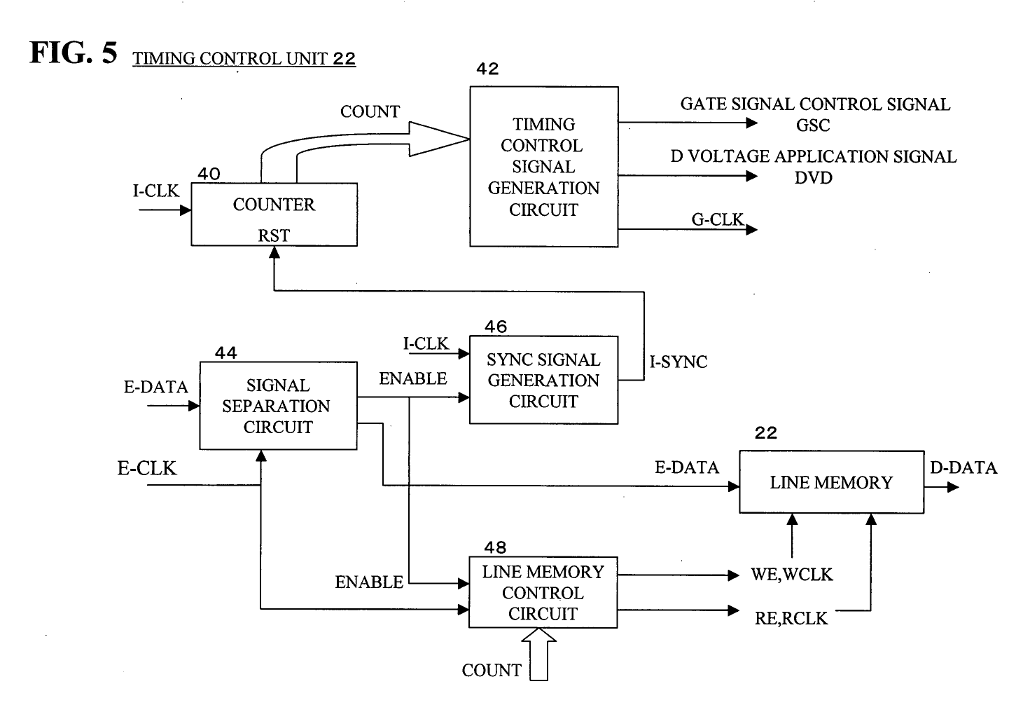

FIG. 5 shows the configuration of the timing control unit 22 in the display control device of the aspect. In the figure, in addition to the configuration of the timing control unit 22, the line memory 22 is also shown. The timing control unit 22 has a signal separation circuit 44 which separates sync information and image data from the input image data E-DATA; the signal separation circuit 44 generates an enable signal ENABLE in synchronization with the input clock E-CLK based on the separated sync information, and also supplies the separated image data D-DATA to the line memory 22. This line memory 22 is for example a dual-port memory unit having a write input terminal and read output terminal to enable simultaneous writing and reading; operations to write image data to the line memory are controlled by a write enable signal WE and write clock WCLK generated by the line memory control circuit 48, and operations to read image data are controlled by a read enable signal RE and read clock RCLK generated by the line memory control circuit 48. The line memory control circuit 48 generates a write enable signal WE and write clock WCLK in synchronization with the enable signal ENABLE and input clock E-CLK, to write supplied image data E-DATA to the line memory 22 in synchronization with the input clock.

The sync signal generation circuit 46 withtin the timing control unit 22 generates an internal sync signal I-SYNC in synchronization with the internal clock I-CLK based on the timing of the enable signal ENABLE, and supplies this signal to the counter 40 as a reset signal RST. The counter 40, upon being reset by the reset signal RST, performs counting operation in synchronization with the internal clock I-CLK. The count value COUNT of the counter is supplied to the timing control signal generation circuit 42, which generates timing control signals from the gate clock G-CLK, gate signal control signal GSC, and data voltage application signal DVD with the timing of a preset count value. The line memory control circuit 48 within the timing control unit 22 inputs this count value COUNT and generates a read enable signal RE and read clock RCLK with the timing of a preset count value, to control operations to read the line memory 22.

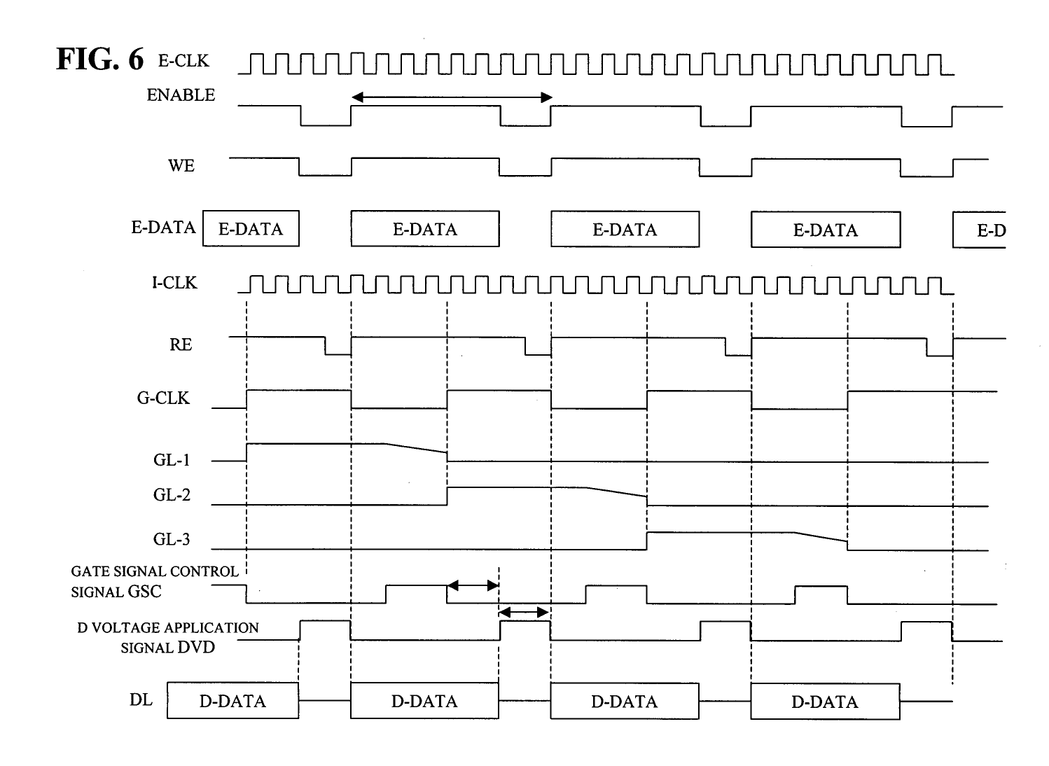

FIG. 6 shows the operating waveforms of the display control device in the aspect. The write enable signal WE is generated in response to the enable signal ENABLE synchronized with the input clock E-CLK, and based on this write enable signal WE, input image data E-DATA is written to the line memory 22. On the other hand, the read enable signal RE, gate clock G-CLK, gate signal control signal GSC, and data voltage application signal DVD are generated based on the count value COUNT of the counter 40 generated in synchronization with the internal clock I-CLK and internal sync signal I-SYNC, which is generated in synchronization with the internal clock I-CLK. That is, these timing control signals provide timing according to design, synchronized with the internal clock I-CLK with a constant period, which is independent of the external clock E-CLK.

First, in response to the read enable signal RE, image data D-DATA in the line memory 22 is read and supplied to the data driver. On the other hand, in response to the gate clock G-CLK, gate lines are driven to H level in sequence, and in response to the gate signal control signal GSC, the gate voltage drops. And in response to the data voltage application signal DVD, the data driver applies data voltages corresponding to the image data D-DATA to data lines. Thus internal timing control signals are all synchronized on the internal clock I-CLK and so have timing according to design, so that the short-circuit interval across data lines (charge-sharing interval) tSC, and the data hold interval DH over which data voltages continued to be applied to data lines after the end of voltage application to gate lines, can be held to the time durations according to design.

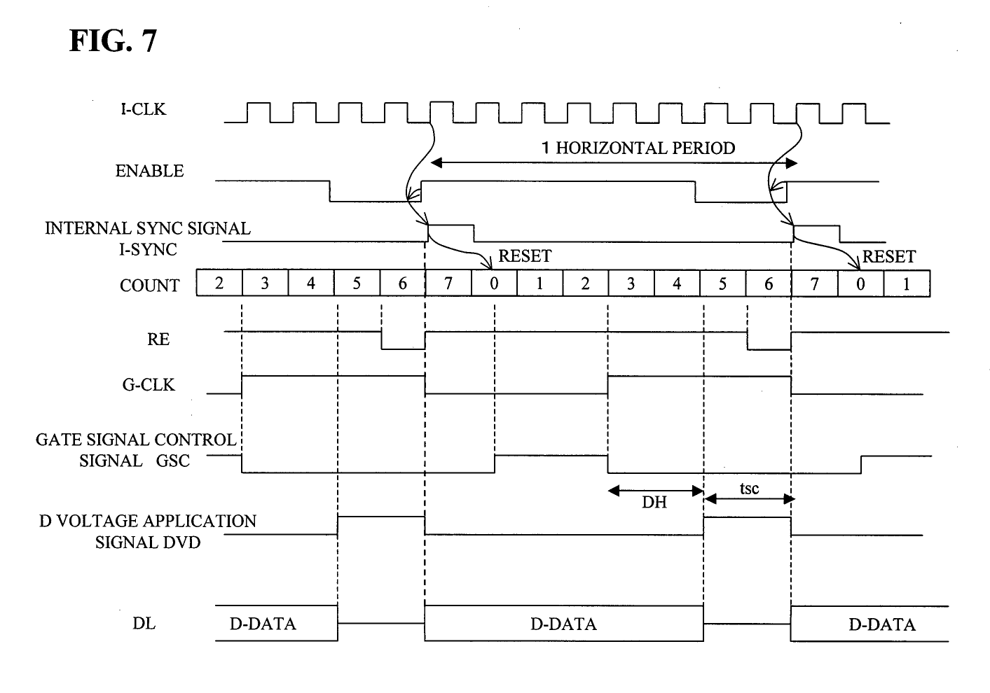

FIG. 7 shows the operating waveforms of the display control device in the aspect. At the rising edge of the enable signal ENABLE in synchronization with the input clock E-CLK, the internal sync signal I-SYNC is generated in synchronization with the internal clock I-CLK, and the counter reset by this internal sync signal I-SYNC counts up (or counts down) in synchronization with the internal clock I-CLK. Based on the count value COUNT of this counter, the timing control signals, that is, the read enable signal RE, gate clock signal G-CLK, gate signal control signal GSC, and data voltage application signal DVD are generated. For example, the gate clock signal G-CLK goes to H level the next time the count value COUNT becomes “2”, and goes to L level the next time the count value becomes “6”. The other control signals are also driven to H or L level at the count values shown in FIG. 7.

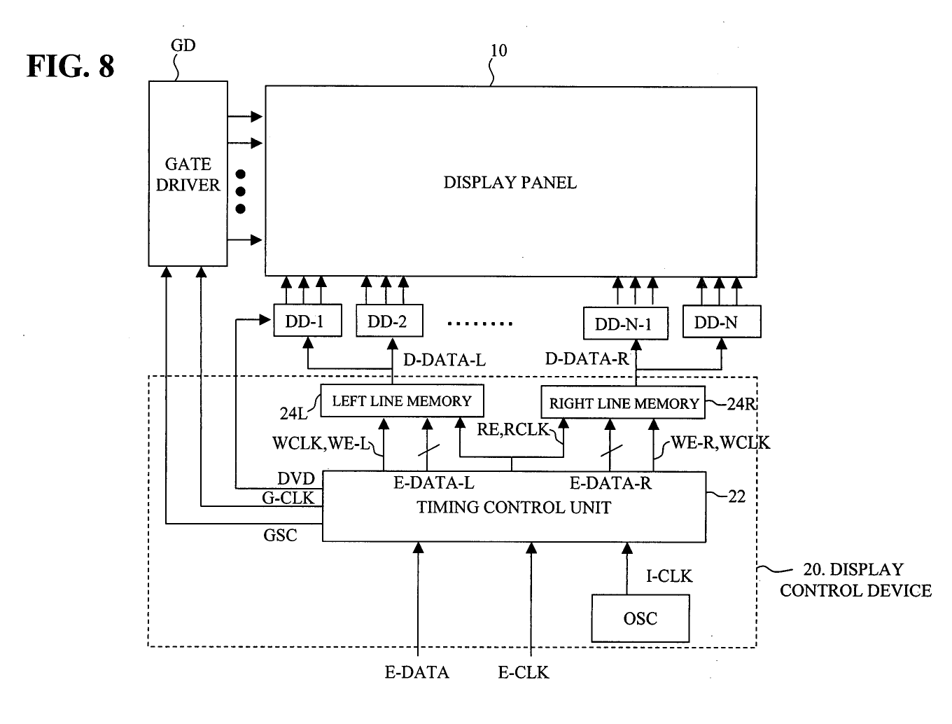

FIG. 8 shows the configuration of a liquid crystal display apparatus in a modified example of the aspect. As disclosed in Japanese Patent Laid-open No. 2003-66911, in this modified example the line memory is divided into a plurality of portions, input image data is written serially to the plurality of line memory portions, and image data is read in parallel from the plurality of line memory portions and is supplied to data drivers. In this case, the writing of input image data to line memory portions is performed in synchronization with the input clock E-CLK, and timing control of reading from line memory portions and of the display panel drivers is synchronized with the internal clock I-CLK.

As shown in FIG. 8, the display control device 20 has a timing control unit 22, left line memory 24L, and right line memory 24R. The timing control unit 22 writes the image data D-DATA-L of the left side of one line to the left line memory 24L in synchronization with the input clock E-CLK with the timing of the write enable signal WE-L, and writes the image data D-DATA-R of the right side of one line to the right line memory 24R in synchronization with the input clock E-CLK with the timing of the write enable signal WE-R. The image data D-DATA is supplied serially in pixel units from the display signal supply apparatus in synchronization with the input clock E-CLK, so that the timing control unit 22 writes the image data E-DATA-L and E-DATA-R serially to the left line memory 24L and to the right line memory 24R in synchronization with the input clock E-CLK.

On the other hand, the timing control unit 22 reads the image data I-DATA-L, I-DATA-R written to the left and right line memories 24L, 24R in parallel with the timing of the read enable signal RE in synchronization with the internal clock I-CLK, and supplies the data to the corresponding data drivers DD. At this time, the read clock RCLK is synchronized with the internal clock ICLK, and it is preferable that this clock be faster than for example the input clock E-CLK. By this means, the image data in the left and right line memories can be transferred to the data drivers in a short time. The gate clock G-CLK for the gate driver GD, the gate signal control signal GSC, and the data voltage application signal DVD for data drivers DD are, as in the aspect described above, generated in synchronization with the internal clock I-CLK.

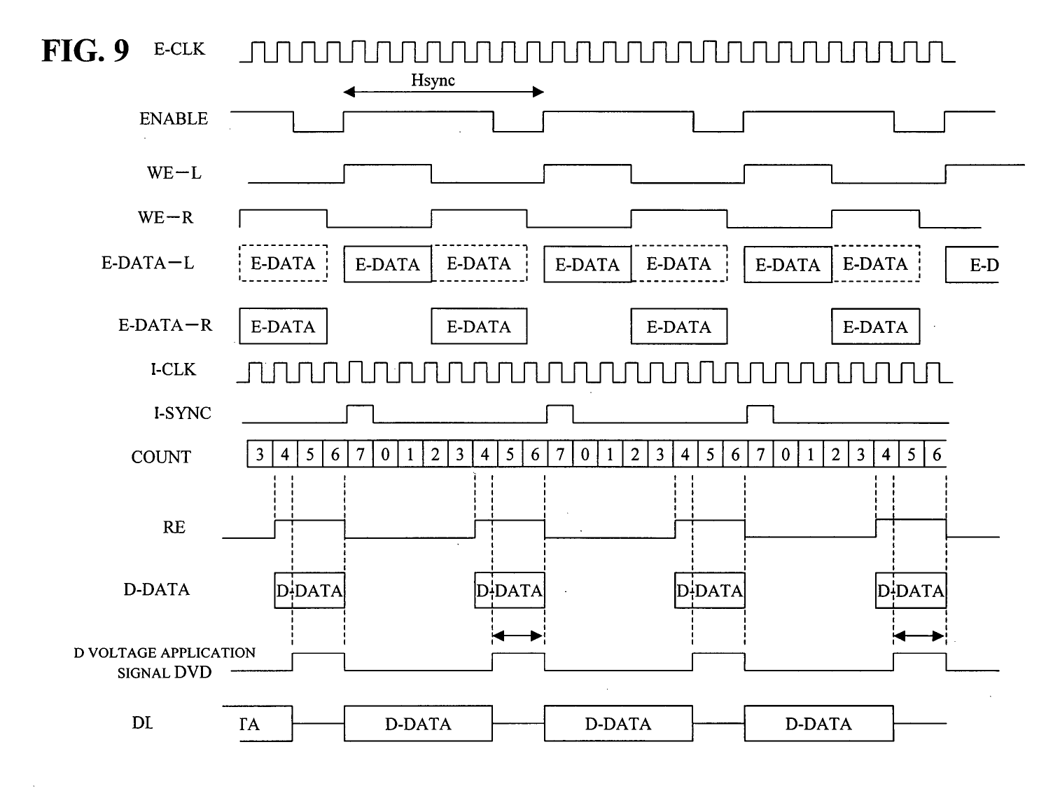

FIG. 9 shows the operating waveforms in the display control device of FIG. 8. The write enable signals WE-L, WE-R are generated based on the input clock E-CLK and enable signal ENABLE, and based on these the input image data E-DATA-L, E-DATA-R are written to the left and right line memories 24L, 24R, respectively. On the other hand, an internal sync signal I-SYNC is generated in synchronization with the internal clock I-CLK, and is used to reset the counter in the timing control unit 22, so that the counter counts up in synchronization with the internal clock I-CLK. Based on the count value COUNT of this counter, the read enable signal RE and data voltage application signal DVD are generated. As explained above, in response to the read enable signal RE image data is read in parallel from the left and right line memories 24L and 24R and is supplied to data drivers. IN order to shorten this reading interval, it is preferable that read operations be performed in synchronization with a read clock RCLK which is synchronized with the internal clock I-CLK and which moreover is faster than the external clock E-CLK. By means of parallel reading and a fast read clock, the time for transfer of image data from line memories to data drivers can be shortened. Moreover, the transfer of image data from line memories to data drivers is synchronized with the internal clock, and so does not depend on the frequency of the supplied input clock, and so stable image data transfer can be performed.

Further, dual-port memory is adopted as the left and right line memories so that serial writing of image data can be performed simultaneously with parallel reading of data. And as shown in FIG. 9, parallel reading is begun before the end of writing to the left and right line memories.

What is claimed is:

1. A display control device, to which is supplied an external clock signal and an image data, and which supplies a timing control signal controlling a timing of driving to a data driver and a gate driver of a liquid crystal display panel, comprising:
an internal clock generation unit which generates an internal clock signal without depending on the external clock signal;
a buffer memory to which the supplied image data is written in synchronization with the external clock signal; and,
a timing control unit which supplies the image data written to the buffer memory to the data driver in synchronization with the internal clock signal, and generates the timing control signal for the data driver and the gate driver in synchronization with the internal clock signal.

2. The display control device according to claim 1, wherein the timing control signal includes a data voltage application signal which controls a timing of application to the data line by the data driver of data voltage corresponding to the image data, and a gate clock signal which controls a timing of driving of the gate line by the gate driver.

3. The display control device according to claim 1, wherein the timing control unit controls a data hold time over which application of data voltage to the data lines is continued after the end of driving of the gate line, in synchronization with the internal clock signal.

4. The display control device according to claim 1, wherein the timing control unit controls a charge-sharing time during which adjacent data lines are short-circuited in advance of application of data voltage to the data line, in synchronization with the internal clock signal.

5. The display control device according to claim 1, wherein the internal clock signal has a constant frequency, without depending on a frequency of the external clock signal.

6. The display control device according to claim 1 or claim 5, further comprising a counter which resets a count value in response to an internal synchronization signal generated in response to an externally supplied display synchronization signal and in synchronization with the internal clock signal, and which is incremented or decremented in synchronization with the internal clock signal; and wherein
the timing control unit generates the timing control signal based on the count value of the counter.

7. The display control device according to claim 1, wherein the buffer memory is a line memory which stores one line's worth of the image data.

8. The display control device according to claim 1, wherein the buffer memory is a plurality of divided line memory which divide and store one line's worth of the image data; and,
the timing control unit writes in serial the image data to the plurality of divided line memory in synchronization with the external clock signal, reads in parallel the image data stored in the plurality of divided line memory in synchronization with the internal clock signal, and supplies the image data to the data driver.

9. A display control device, to which is supplied an external clock signal and an image data corresponding to a display synchronization signal, and which supplies a timing control signal controlling a timing of driving to a data driver and a gate driver of a liquid crystal display panel, comprising:
an internal clock generation unit which generates an internal clock signal with a constant frequency without depending on the external clock signal;
a first and second line memory to which the supplied image data is serially written in synchronization with the external clock signal; and,
a timing control unit which reads in parallel the image data written to the first and second line memory in synchronization with the internal clock signal and supplies the image data to the data driver, and which generates the timing control signal for the data driver and gate driver in synchronization with the internal clock signal.

10. The display control device according to claim 9, wherein the timing control signal includes a data voltage application signal which controls a timing of application to a data line by the data drivers of data voltages corresponding to the image data, and a gate clock signal controls a timing of driving of a gate line by the gate driver.

11. The display control device according to claim 9, wherein the timing control unit controls a data hold time over which application of data voltage to the data line is continued after the end of driving of the gate line, in synchronization with the internal clock signal.

12. The display control device according to claim 9, wherein the timing control unit controls a charge-sharing time during which adjacent data lines are short-circuited in advance of application of data voltages to the data line, in synchronization with the internal clock signal.

13. A liquid crystal display apparatus, comprising a display control device to which is supplied an external clock signal and an image data, and which supplies a timing control signal controlling a timing of driving to a data driver and a gate driver of a liquid crystal display panel, wherein the display control device comprises:
an internal clock generation unit which generates an internal clock signal without depending on the external clock signal;
a buffer memory to which the supplied image data is written in synchronization with the external clock signal; and,
a timing control unit which supplies the image data written to the buffer memory to the data driver in synchronization with the internal clock signal, and which generates the timing control signal for the data driver and gate driver in synchronization with the internal clock signal.

14. A liquid crystal display apparatus, comprising a display control device to which is supplied an external clock signal and an image data corresponding to a display synchronization signal, and which supplies a timing control signal controlling a timing of driving to a data driver and a gate driver of a liquid crystal display panel, comprising:
an internal clock generation unit which generates an internal clock signal with a constant frequency without depending on the external clock signal;
a first and second line memory to which the supplied image data is serially written in synchronization with the external clock signal; and,
a timing control unit which reads in parallel the image data written to the first and second line memory in synchronization with the internal clock signal, and which generates the timing control signal for the data driver and gate driver in synchronization with the internal clock signal.
